(19) United States
(12) Patent Application Publication
(10) Pub. No.: US 2026/0184872 A1
(43) Pub. Date: Jul. 2, 2026

(54) FOAMABLE CELLULOSE ACETATE COMPOSITIONS COMPRISING CARBON DIOXIDE AND A CHEMICAL BLOWING AGENT AND FOAMS FORMED THEREFROM

(71) Applicant: EASTMAN CHEMICAL COMPANY, KINGSPORT, TN (US)

(72) Inventors: GAURAV AMARPURI, ALPHARETTA, GA (US); MICHAEL EUGENE DONELSON, KINGSPORT, TN (US); WAYNE KEN SHIH, MARYSVILLE, WA (US)

(73) Assignee: EASTMAN CHEMICAL COMPANY, KINGSPORT, TN (US)

(21) Appl. No.: 19/113,075

(22) PCT Filed: Sep. 21, 2023
(86) PCT No.: PCT/US2023/074775

§ 371 Date: Mar. 19, 2025

Related U.S. Application Data
(60) Provisional application No. 63/409,460, filed on Sep. 23, 2022.

(51) Int. Cl. C08J 9/00; C08J 9/08; C08J 9/12

(52) U.S. Cl. CPC C08J 9/0061; C08J 9/08; C08J 9/122; C08J 2203/06; C08J 2205/052; C08J 2301/12

(57) ABSTRACT

The present application discloses foamable compositions comprising cellulose acetate and a combination of a carbon dioxide as a physical blowing agent and a chemical blowing agent. The foamable compositions are used to prepare foams that exhibit lower density, lower average foam cell size, and fewer corrugations than foams made only by carbon dioxide.

### BACKGROUND OF THE INVENTION

Carbon dioxide is a commercially relevant blowing agent for producing extruded foam sheets. However, cellulose acetate based foams prepared using carbon dioxide only as a physical blowing agent exhibit average foam cell sizes of around 350 microns with significant corrugations. Applicants have surprisingly discovered that the combination of a carbon dioxide and a chemical blowing agent can lower the average foam cell size and lower the occurrence of corrugations in foams prepared by extrusion. The foams also exhibit lower densities as compared to foams formed from carbon dioxide only.

### SUMMARY OF THE INVENTION

The present application discloses a foamable composition comprising:
(i) a cellulose acetate;
(ii) a nucleating agent;
(iii) a plasticizer;
(iv) physical blowing agent, which is carbon dioxide; and
(v) a chemical blowing composition,
wherein:
the plasticizer is present at from 5 to 40 wt %,
the nucleating agent is present at from 0.1 to 3 wt %,
the physical blowing agent is present at from 0.1 to 5 wt %, and
the chemical blowing agent is present at from 0.1 to 5 wt %,
each based on the total weight of the composition.

The present application also discloses foams formed from the foamable composition.

### DETAILED DESCRIPTION OF THE INVENTION

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles and other written text throughout this specification (referenced materials herein). Each of the referenced materials is individually incorporated herein by reference in its entirety for the referenced teaching, to the extent it does not contradict any specific teachings provided herein.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the example(s) or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art.

### Definitions

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agent may act to reduce density by forming cells in the molten formulation at the nucleation sites. The blowing agent may be added to a molten resin mixture, composition or melt in the extruder, for example by injection.

“Chemical blowing agent” are materials that degrade, decompose or react to produce a gas. The chemical blowing agents typical include a chemical blowing composition and a carrier polymer. Chemical blowing agents may be endothermic or exothermic. The chemical blowing composition in the chemical blowing agents typically degrade at a certain temperature to decompose and release gas. Examples of chemical blowing composition used in chemical blowing agents include citric acid, sodium bicarbonate, sodium carbonate, ammonium bicarbonate, ammonium carbonate, and the like.

Examples of “physical blowing agents” include N₂, CO₂, alkanes, alkenes, ethers, esters, ketones, argon, helium, air, water or mixtures thereof.

Nucleating agent means a physical material that provides sites for cells to form in a molten formulation mixture, such as within a CE melt resin. As will be described in more detail below, nucleating agents may be added to compounded CE material during the compounding process. Alternatively, or in addition, nucleating agents may be added during the foam sheet production process. For example, the nucleating agents may be blended with the formulation that is introduced into the hopper of the extruder of the extruding section. Alternatively, the nucleating agents may be added to the CE melt resin in the extruder itself. Physical nucleating agents are materials that are immiscible with the polymer matrix of the CE melt resin at the extrusion temperature of the extrusion section. Materials that react (e.g., decompose) during extrusion (e.g., at the extrusion temperature within the extruder) to form physical nucleating agents are called chemical nucleating agent. Thus, chemical nucleating agents may be considered (and referred to herein as) precursors of in situ formed physical nucleating agents. Nucleating agent does not include chemical nucleating agents. Thus, chemical nucleating agents may be considered (and referred to herein as) precursors of in situ formed physical nucleating agents.

Suitable physical nucleating agents (i.e., nucleating agents) will comprise fine particles having desirable particle sizes and/or shapes to create cell nucleation sites within the CE melt resin. For example, in some embodiments, physical nucleating agents will have a mean particle size of less than 1000 microns, less than 500 microns, less than 100 microns, less than 50 microns, less than 25 microns, less than 20 microns, less than 10 microns, less than 5 microns, less than 2 microns, less than 1.5 microns, and/or less than 1.0 microns. However, in some other embodiments, it may be preferred to have nanoscale-sized particles. Furthermore, it some embodiments, physical nucleating agents will preferably have a high aspect ratio (i.e., width:height). For example, in some embodiments, physical nucleating agents will have a mean aspect ratio of greater than 1:1, greater than 2:1, greater than 5:1, greater than 10:1, greater than 20:1, greater than 30:1, greater than 40:1, greater than 50:1, greater than 75:1, and/or greater than 100:1. Furthermore still, as noted above, physical nucleating agents should be immiscible with the polymer matrix of the CE melt resin at the extrusion temperature of the extrusion section. As such, in some embodiments, the physical nucleating agents should have a melting temperature at least 220° C., at least 230° C. of at least 240° C., at least 250° C., at least 275° C., at least 300° C., at least 325° C., or at least 350° C. Nevertheless, the physical nucleating agents may be selected such that they have the ability to, after melting, recrystallize upon cooling.

Examples of suitable inorganic physical nucleating agents include, but are not limited to, minerals such as talc, CaCO₃, mica, and mixtures of at least two of the foregoing. One representative example is Heritage Plastics HT6000 Linear Low Density Polyethylene (LLDPE) Based Talc Concentrate. Other inorganic physical nucleating agents include wollastonite, silica, silicon oxide, titanium oxide, magnesium oxide, aluminum oxide and calcium silicate, barium sulfate, Kaolin, aluminum tryhydrateATH (Al(OH)₃), MDH (Mg(OH)₂), Diatomaceous earth, magnetite/hematite, halloysite, zinc oxide, and titanium dioxide. In some embodiments, the inorganic nucleating agents will comprise oxides, such as metal oxides or mixed metal oxides, such as those selected from one or more of the following: aluminum oxide, antimony oxide, arsenic oxide, bismuth oxide, boron oxide, calcium oxide, gallium oxide, iron oxide, lithium oxide, magnesium oxide, silicon oxide, and titanium oxide. In other embodiments, the inorganic nucleating agents comprises minerals. In other embodiments, the nucleating agents are selected form one or more of the following: sodium bicarbonate, sodium carbonate, ammonium bicarbonate, ammonium carbonate, calcium carbonate, and zinc carbonate. In other embodiments, the inorganic nucleating agents will comprise silicates, such as silicates selected from one or of the following: magnesium silicate and calcium silicate. The inorganic nucleating agents can be in the form of fine particles.

It has been discovered that biodegradable natural, particulate materials derived from renewable organic sources (e.g., organic nucleating agents) can also serve as effective physical nucleating agents. Natural materials that can be physical nucleating agents include material comprised of cellulose fibers and/or cellulose starch. Examples include, but are not limited to almond shell flour, animal fiber, apricot shell flour, bamboo flour, tree bark flour, clam shell flour, coconut shell flour, coconut coir, cork flour, corn cob flour, corn cob grit, cottonseed hulls, flock & fiber, hazelnut shell flour, kenaf flour, natural fibers, nutshell hull & flour, oat fiber powder, olive stone flour, peanut hulls flour, pecan shell flour, pine-nut shell powder, pistachio-nut shell flour, plant fiber, rice hull flour, rice hull grit, rice husk, soy bean flour, starch flour (hydrophobic), walnut shell flour, wheat chaff, wheat husk, and wood flour. Other organic physical nucleating agents include cellulose powder, chitin, chitosan, stearic acid metal salts, carbon black, and dolomite.

In one embodiment or in combination with any of the embodiments mentioned herein, the nucleating agents are present at from 0.1 to 10 wt %, from 0.1 to 5.0 wt %, at least 0.1 wt %, at least 0.25 wt %, at least 0.5 wt % at least 1.0 wt %, at least 1.25 wt %, at least 1.5 wt %, at least 1.75 wt %, at least 2.0 wt %, at least 2.25 wt %, at least 2.5 wt %, at least 2.75 wt %, or at least 3.0 wt %, or at least 3.5 wt %, or at least 4.0 wt %, or at least 4.5 wt % and/or less than 7.5 wt %, less than 5 wt %, less than 4 wt %, less than 3 wt %, less than 2 wt %, or less than 1.0 wt %, all based on the total weight of the cellulose ester composition. In some embodiments, the nucleating agents used herein may comprise a combination or mixture of two or more different types of nucleating agents.

It is noted that the cellulose ester material, whether in the form of compounded CE material or CE melt resin, will generally be able to accept a maximum amount of nucleating agent that can function to form nucleation sites. Any remaining nucleating agent that is added to the cellulose ester material will remain as filler. Fillers can provide various properties to the resulting cellulose ester foams and/or articles based on the type of filler used. For example, some fillers can provide increased/decreased density, ductility, Young's modulus, yield strength, heat deflection temperature, permeability, impact resistance, elongation to break, adhesion properties, biodegradation, etc. of the cellulose ester material. Fillers can also be used to alter the visual characteristics (e.g., color, opacity, etc.) and tactile characteristics (e.g., material continuous, surface roughness, etc.) of the cellulose ester material.

### Cellulose Acetate

In embodiments, the cellulose acetate utilized in this invention can be any that is known in the art and that is biodegradable. Cellulose acetate that can be used for the present invention generally comprise repeating units of the structure:

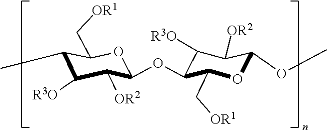

wherein R¹, R², and R³ are selected independently from the group consisting of hydrogen or acetyl. For cellulose esters, the substitution level is usually express in terms of average degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In embodiments, n is an integer in a range from 25 to 250, or 25 to 200, or 25 to 150, or 25 to 100, or 25 to 75.

Cellulose acetates can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose acetates, can be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substitutents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

The present application discloses a foamable composition comprising: (i) a cellulose acetate; (ii) a nucleating agent; (iii) a plasticizer; (iv) physical blowing agent, which is carbon dioxide; and (v) a chemical blowing composition, wherein: the plasticizer is present at from 5 to 40 wt %, the nucleating agent is present at from 0.1 to 3 wt %, the physical blowing agent is present at from 0.1 to 5 wt %, and the chemical blowing agent is present at from 0.1 to 5 wt %, each based on the total weight of the composition.

In one embodiment or in combination with any other embodiment, the foamable composition further comprises a second physical blowing agent which is different than the physical blowing agent, which is carbon dioxide. In one class of this embodiment, the second physical blowing agent is N₂, (C₁₋₆)alkane, (C₂₋₆)alkene, (C₁₋₆)alkanol, (C₁₋₆)alkane-C(O)—(C₁₋₆)alkane, or combinations thereof. In one subclass of this class, the second physical blowing agent is present at from 0.1 to 4 wt %, based on the total weight of the composition.

In one embodiment or in combination with any other embodiment, the cellulose acetate has an average degree of substitution for acetyl substituents (“DS_{Ac}”) that is from 1.8 to 2.6. In one embodiment or in combination with any other embodiment, the cellulose acetate has an average degree of substitution for acetyl substituents (“DS_{Ac}”) that is from 2.2 to 2.6. In one embodiment or in combination with any other embodiment, the cellulose acetate has an average degree of substitution for acetyl substituents (“DS_{Ac}”) that is from 2.1 to 2.6. In one embodiment or in combination with any other embodiment, the cellulose acetate has an average degree of substitution for acetyl substituents (“DS_{Ac}”) that is from 2.1 to 2.5.

In one embodiment or in combination with any other embodiment, the cellulose acetate exhibits a weight average molecular weight (“Mw”) that is greater 50,000 Daltons. In one embodiment or in combination with any other embodiment, the cellulose acetate exhibits a weight average molecular weight (“Mw”) that is from 50,000-200,000 Daltons. In one embodiment or in combination with any other embodiment, the cellulose acetate exhibits a weight average molecular weight (“Mw”) that is from 50,000-100,000 Daltons. The molecular weights can be measured using NMP as solvent according to ASTM D4674.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose acetates useful in the present invention can be prepared using techniques known in the art and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10.

In embodiments of the invention, the cellulose acetate can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose acetate composition comprising at least one recycle cellulose acetate is provided, wherein the cellulose acetate has at least one substituent on an anhydroglucose unit (AU) derived from recycled content material, e.g., recycled plastic content syngas.

In one embodiment or in combination with any other embodiment, the foamable composition further comprises at least one of a filler, additive, biopolymer, stabilizer, and/or odor modifier. Examples of additives include waxes, compatibilizers, biodegradation promoters, dyes, pigments, colorants, luster control agents, lubricants, anti-oxidants, viscosity modifiers, antifungal agents, anti-fogging agents, heat stabilizers, impact modifiers, antibacterial agents, softening agents, mold release agents, and combinations thereof. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment, the plasticizer is a food-compliant plasticizer. In one embodiment or in combination with any other embodiment, By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA.

In one embodiment or in combination with any other embodiment, the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate, glycolates, polyethylene glycol, 2,2,4-trimethylpentane-1,3-diyl bis(2-methylpropanoate), and polycaprolactones.

In one embodiment or in combination with any other embodiment, wherein the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, wherein the plasticizer is triacetin, triethyl citrate, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

In one embodiment or in combination with any other embodiment, wherein the plasticizer is triacetin.

In one embodiment or in combination with any other embodiment, the physical blowing agent is present at from 0.1 to 4 wt %, or from 0.1 to 3 wt %, or from 0.1 to 2.5 wt %, or from 0.1 to 2 wt %, or from 0.1 to 1 wt %, or form 0.5 to 5 wt %, or from 0.5 to 4 wt %, or from 0.5 to 3 wt %, or from 0.5 to 2.5 wt %, or from 0.5 to 2 wt %, or from 0.5 to 1.5 wt %, or from 0.5 to 1 wt %, or from 1 to 5 wt %, or from 1.0 to 4 wt %, or from 1 to 3 wt %, or from 1 to 2.5 wt %, or from 1 to 2 wt %, or from 1.5 to 5 wt %, or from 1.5 to 4 wt %, or from 1.5 to 3 wt %, or from 1.5 to 2.5 wt %, or from 1.5 to 2 wt %, or from 2 to 5 wt %, or from 2 to 4 wt %, or from 2 to 3 wt %, or from 1.75 to 2.5 wt %, or from 1.75 to 2.0 wt %, or less than 1.75 wt %.

In one embodiment or in combination with any other embodiment, the chemical blowing agent is biodegradable. In one embodiment or in combination with any other embodiment, the carrier polymer is biodegradable.

In one embodiment or in combination with any other embodiment, the chemical blowing composition is present at from 0.1 to 4 wt %, or 0.1 to 3 wt %, or 0.1 to 2 wt %, or 0.1 to 1.5 wt %,

In one embodiment or in combination with any other embodiment, the chemical blowing agent comprises (a) a blowing agent; (b) a carrier polymer having a melting point that is no more than 180° C.

In one class of this embodiment or in combination with any other class of this embodiment, the blowing agent comprises a bicarbonate salt, a carbonate salt, citric acid, or combinations thereof. The bicarbonate salt or carbonate salt may be sodium, carbonate, magnesium salts and the like. In one subclass of this class, the blowing gent comprises sodium bicarbonate, sodium carbonate, citric acid, or combinations thereof.

In one class of this embodiment or in combination with any other class of this embodiment, the carrier polymer comprises a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof. In one subclass of this class, the carrier polymer comprises a PBS. In one subclass of this class, the carrier polymer comprises a PCL. In one subclass of this class, the carrier polymer is a PLA. In one subclass of this class, the carrier polymer is a PHA. In one subclass of this class, the carrier polymer is a PBAT. In one subclass of this class the carrier polymer is a starch. In one subclass of this class, the carrier polymer is PBSA.

In one class of this embodiment or in combination with any other class of this embodiment, the carrier polymer is present at from 25 to 75 wt %, or 25 to 65 wt %, or 25 to 55 wt %, or 25 to 45 wt %, or 25 to 35 wt %, or 35 to 75 wt %, or 35 to 65 wt %, or 35 to 55 wt %, or 35 to 45 wt %, or 45 to 75 wt %, or 45 to 65 wt %, or 45 to 55 wt %, or 55 to 75 wt %, or 55 to 65 wt %, or 65 to 75 wt %, based on the total weight of the chemical blowing agent.

In one embodiment or in combination with any other embodiment, the foamable composition further comprises at least one stabilizer. Although it is desirable for the foamable composition to be composable and/or biodegradable, a certain amount of stabilizer may be added to provide a selected shelf life or stability, e.g., towards light exposure, oxidative stability, or hydrolytic stability. In various embodiments, stabilizers can include: UV absorbers, antioxidants (ascorbic acid, BHT, BHA, etc.), other acid and radical scavengers, epoxidized oils, e.g., epoxidized soybean oil, or combinations thereof.

Antioxidants can be classified into several classes, including primary antioxidant, and secondary antioxidant. Primary antioxidants a generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In embodiments, the foamable composition comprises at least one stabilizer, wherein the stabilizer comprises one or more secondary antioxidants. In embodiments, the stabilizer comprises a first stabilizer component chosen from one or more secondary antioxidants and a second stabilizer component chosen from one or more primary antioxidants, citric acid or a combination thereof.

In embodiments, the stabilizer comprises one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent of the total amount of secondary antioxidants based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In one subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In one subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In one embodiment or in combination with any other embodiment, the foamable composition comprises at least one filler. In one class of this embodiment or in combination with any other class, the filler is of a type and present in an amount to enhance biodegradability and/or compostability. In one class of this embodiment or in combination with any other class, the foamable composition comprises at least one filler chosen from: carbohydrates (sugars and salts), cellulosic and organic fillers (wood flour, wood fibers, hemp, carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes or byproduct (eggshells, distillers grain, and coffee grounds), desiccants (e.g. calcium sulfate, magnesium sulfate, magnesium oxide, calcium oxide), alkaline fillers (e.g., Na₂CO₃, MgCO₃), or combinations (e.g., mixtures) of these fillers. In one class of this embodiment or in combination with any other class, the foamable composition can include at least one filler that also functions as a colorant additive. In one subclass of this class, the colorant additive filler can be chosen from: carbon, graphite, titanium dioxide, opacifiers, dyes, pigments, toners and combinations thereof. In one class of this embodiment or in combination with any other class, the cellulose acetate compositions can include at least one filler that also functions as a stabilizer or flame retardant.

In one embodiment or in combination with any other embodiment, other components that can be included in the foamable composition may function as release agents or lubricants (e.g. fatty acids, ethylene glycol distearate), anti-block or slip agents (e.g. fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers. More than one component may be present in the foambable composition. It should be noted that an additional component may serve more than one function in the foamable composition. The different (or specific) functionality of any particular additive (or component) to the foamable composition can be dependent on its physical properties (e.g., molecular weight, solubility, melt temperature, Tg, etc.) and/or the amount of such additive/component in the overall composition. For example, polyethylene glycol can function as a plasticizer at one molecular weight or as a hydrophilic agent (with little or no plasticizing effect) at another molecular weight.

In one embodiment or in combination with any other embodiment, the foamable composition further comprises 0.1 to 50 wt % of a biodegradable polymer which is different than the cellulose acetate, based on the total weight of the foamable composition.

In one class of this embodiment, or in combination with any other class of this embodiment, the biodegradable polymer is a cellulose ester that is different than the cellulose acetate, a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof. In one subclass of this class, the biodegradable polymer is the PBS, the PCL, or the PHA. In one subclass of this class, the biodegradable polymer is the cellulose ester that is different than the cellulose acetate. The cellulose ester can be a cellulose acetate so long as the cellulose acetate is different than the cellulose acetate as comprised in the biodegradable polymer. For example, the cellulose acetate of the biodegradable polymer can have an average degree of substitution that is less than 1.8.

The present application also discloses a foam formed from the foamable composition disclosed herein, wherein the foam is biodegradable.

In one embodiment or in combination with any other embodiment, the foam has a density of less than 0.2 g/cm³, or less than 0.18 g/cm³, or less than 0.16 g/cm³, or less than 0.14 g/cm³, or less than 0.13 g/cm³, or less than 0.12 g/cm³, or less than 0.11 g/cm³, or less than 0.1 g/cm³, or in the range of from 0.1 to 0.2 g/cm³, or in the range of from 0.1 to 0.18 g/cm³, or in the range of from 0.1 to 0.16 g/cm³, or in the range of from 0.1 to 0.14 g/cm³, or in the range of from 0.1 to 0.13 g/cm³, or in the range of from 0.1 to 0.12 g/cm³, or less than 0.14 g/cm³, or less than 0.1 g/cm³.

In one embodiment or in combination with any other embodiment, the foam has an average foam cell size of less than 400 microns, or less than 375 microns, or less than 350 microns, or less than 325 microns, or less than 300 microns, or less than 275 microns, or less than 250 microns, or less than 225 microns, or less than 200 microns, or less than 175 microns, or in the range of from 250 to 400 microns, or in the range of from 250 to 375 microns, or in the range of from 250 to 350 microns, or in the range of from 250 to 325 microns, or in the range of from 250 to 300 microns, or in the range of from 250 to 275 microns, or in the range of from 275 to 400, or in the range of from 275 to 375 microns, or in the range of from 275 to 350 microns, or in the range of from 275 to 325 microns, or in the range of from 275 to 300 microns, or in the range of from 300 to 400 microns, or in the range of from 300 to 375 microns, or in the range of from 300 to 350 microns, or in the range of from 180 to 350 microns, or in the range of from 180 to 325 microns, or in the range of from 180 to 300 microns, or in the range of from 180 to 275 microns, or in the range of from 180 to 250 microns, or in the range of from 180 to 225 microns, or in the range of from 180 to 200 microns, or in the range of from 150 to 350 microns, or in the range of from 150 to 325 microns, or in the range of from 150 to 300 microns, or in the range of from 150 to 275 microns, or in the range of from 150 to 250 microns, or in the range of from 150 to 200 microns.

In one embodiment or in combination with any other embodiment, the foam has a density that is less than 0.14 g/cm³ and an average foam cell size of less than 350 microns. In one embodiment or in combination with any other embodiment, the foam has a density that is less than 0.14 g/cm³, and an average foam cell size of from 180 micron to 350 microns. In one embodiment or in combination with any other embodiment, the foam has a density that is less than 0.1 g/cm³, and the average foam cell size is less than 200 microns. In one embodiment or in combination with any other embodiment, the foam has a density is less than 0.14 g/cm³, and an average foam cell size that is from 150 to 275 microns. In one embodiment or in combination with any other embodiment, the foam has a density that is less than 0.1 g/cm³, and the average foam cell size is less than 200 microns.

In one embodiment or in combination with any other embodiment, the cells of the foam are closed. In one class of this embodiment, 90% of the cells of the foam are closed, or 80% of the cells of the foam are closed, or 70% of the cells of the foam are closed, or 60% of the cells of the foam are closed, or 50% of the cells of the foam are closed, or 40% of the cells of the foam are closed, or 30% of the cells of the foam are closed, or 20% of the cells of the foam are closed, or 10% of the cells of the foam are closed.

In one embodiment or in combination with any other embodiment, the foam exhibits a Rᵣₘₛ surface area roughness that is of less than 21 microns, or less than 20 microns, or less than 19 microns, or less than 18 microns, or less than 17 microns, or less than 16 microns, or less than 15 microns, or less than 14 microns, or from 12 to 21 microns, or from 12 to 20 microns, or from 12 to 18 microns, or from 12 to 16 microns.

In one embodiment or in combination with any other embodiment, the foam is in the form of a sheet.

In one embodiment or in combination with any other embodiment, the sheet exhibits fewer corrugations as compared to a foamed sheet prepared using only carbon dioxide as a physical blowing agent.

In one embodiment or in combination with any other embodiment, the foam comprises one or more outer surfaces and at least one skin on one of the outer surfaces of the foam.

In one embodiment or in combination with any other embodiment, an article is prepared from any of the previously disclosed foams, wherein the article is biodegradable.

In one embodiment, or in combination with any other embodiment, the article is industrial compostable, or home compostable.

The present application also discloses a foamable composition comprising: (i) a cellulose acetate; (ii) a plasticizer; (iii) physical blowing agent, which is carbon dioxide; and (iv) a chemical blowing agent, wherein: the plasticizer is present at from 5 to 40 wt %, the physical blowing agent is present at less than 1.75 wt %, and the chemical blowing agent is present at from 0.1 to 5 wt %, each based on the total weight of the composition, wherein the foamable composition is free of any physical nucleating agent as an additive.

In one embodiment or in combination with any other embodiment, the foam has a density that is less than 0.14 g/cm³, and an average foam cell size of from 180 micron to 350 microns.

The present application discloses a method of preparing a foam, comprising: (i) forming any foamable composition disclosed herein in an extruder; and (ii) thermally expanding the foamable composition under conditions sufficient to form a foam therefrom, wherein the conditions include a melt temperature of from 150° C. to 240° C. and a thermal expansion pressure of from 20 to 250 bar.

In one embodiment or in combination with any other embodiment, the melt temperature is from 150° C. to 230° C., or from 150° C. to 220° C., or from 150° C. to 210° C., or from 150° C. to 200° C., or from 150° C. to 190° C., or from 150° C. to 180° C., or from 150° C. to 170° C., or from 150° C. to 160° C., or from 160° C. to 240° C., or from 160° C. to 200° C., or from 160° C. to 190° C., or from 160° C. to 180° C., or from 160° C. to 170° C., or from 170° C. to 240° C., or from 170° C. to 200° C., or from 170° C. to 190° C., or from 170° C. to 180° C., or from 170° C. to 170° C., or from 180° C. to 240° C., or from 180° C. to 230° C., or from 180° C. to 220° C., or from 180° C. to 210° C., or from 180° C. to 200° C., or from 180° C. to 190° C., or from 190° C. to 240° C., or from 190° C. to 230° C., or from 190° C. to 220° C., or from 190° C. to 210° C., or from 190° C. to 200° C.

In one embodiment or in combination with any other embodiment, the thermal expansion temperature is from 20 to 200 bar, or from 20 to 160 bar, or from 20 to 120 bar, or from 20 to 180 bar, or from 20 to 140 bar, or from 20 to 100 bar, or from 20 to 60 bar, or from 40 to 250 bar, or from 40 to 200 bar, or from 40 to 160 bar, or from 40 to 120 bar, or from 40 to 80 bar, or from 60 to 250 bar, or from 60 to 200 bar, or from 60 to 160 bar, or from 60 to 120 bar, or from 60 to 80 bar, or from 80 to 250 bar, or from 80 to 200 bar, or from 80 to 160 bar, or from 80 to 120 bar, or from 100 to 250 bar, or from 100 to 200 bar, or from 100 to 160 bar, or from 100 to 120 bar, or from 120 to 250 bar, or from 120 to 200 bar, or from 120 to 160 bar, or from 150 to 250 bar, or from 150 to 200 bar, or from 150 to 160 bar.

### SPECIFIC EMBODIMENTS

Embodiment 1. A foamable composition comprising: (i) a cellulose acetate; (ii) a nucleating agent; (iii) a plasticizer; (iv) physical blowing agent, which is carbon dioxide; and (v) a chemical blowing agent, wherein: the plasticizer is present at from 5 to 40 wt %, the nucleating agent is present at from 0.1 to 3 wt %, the physical blowing agent is present at from 0.1 to 5 wt %, and the chemical blowing agent is present at from 0.1 to 5 wt %, each based on the total weight of the composition.
Embodiment 2. The foamable composition of Embodiment 1, wherein the cellulose acetate has an average degree of substitution for acetyl substituents (“DS_{Ac}”) that is from 1.8 to 2.6.
Embodiment 3. The foamable composition of any one of Embodiments 1-2, wherein the chemical blowing agent, comprises: (a) a chemical blowing composition, wherein the chemical blowing composition comprises a bicarbonate salt, a carbonate salt, citric acid, or combinations thereof; (b) a carrier polymer having a melting point that is no more than 180° C.
Embodiment 4. The foamable composition of Embodiment 3, wherein the carrier polymer comprises a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof.
Embodiment 5. The foamable composition of any one of Embodiments 1-4, wherein the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.
Embodiment 6. The foamable composition of any one of Embodiments 1-5, further comprising 0.1 to 50 wt % a biodegradable polymer which is different than the cellulose acetate, based on the total weight of the foamable composition.
Embodiment 7. The foamable composition of Embodiment 6, wherein the biodegradable polymer is a cellulose ester that is different than the cellulose acetate, a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof.
Embodiment 8. The foamable composition of any one of Embodiments 1-7, wherein the physical blowing agent is present at less than 1.75 wt %.
Embodiment 9. The foamable composition of any one of Embodiments 1-8, wherein the physical blowing agent is present at from 1.75 to 2.5 wt %.
Embodiment 10. A foam formed form the composition of any one of Embodiments 1-9, wherein the foam has a density that is less than 0.2 g/cm³ and an average foam cell size of less than 350 microns.
Embodiment 11. A foam formed from the composition of Embodiment 10, wherein the foam has a density is less than 0.14 g/cm³, and an average foam cell size that is from 150 to 275 microns.
Embodiment 12. A foam formed from the composition of Embodiment 10, wherein the foam has a density that is less than 0.1 g/cm³, and the average foam cell size is less than 200 microns.
Embodiment 13. A foamable composition comprising: (i) a cellulose acetate; (ii) a plasticizer; (iii) physical blowing agent, which is carbon dioxide; and (iv) a chemical blowing agent, wherein: the plasticizer is present at from 5 to 40 wt %, the physical blowing agent is present at less than 1.75 wt %, and the chemical blowing agent is present at from 0.1 to 5 wt %, each based on the total weight of the composition, wherein the foamable composition is free of any physical nucleating agent as an additive.
Embodiment 14. A foam formed from the foamable composition of Embodiment 13, wherein the foam has a density that is less than 0.14 g/cm³, and an average foam cell size of from 180 micron to 350 microns.
Embodiment 15. The foam of any one of Embodiments 10-14, wherein the cells of the foam are closed.
Embodiment 16. The foam of any one of Embodiments 10-15, wherein the foam is in the form of a sheet.
Embodiment 17. The foam of Embodiment 16, wherein the sheet exhibits a fewer corrugations as compared to a foamed sheet prepared using only carbon dioxide as a physical blowing agent.
Embodiment 18. The foam of any one of Embodiments 10-17, wherein the foam comprises one or more outer surfaces and at least one skin on one of the outer surfaces of the foam.
Embodiment 19. An article prepared from the foam of any one of Embodiments 10-18, wherein the article is biodegradable.
Embodiment 20. The article of Embodiment 19, wherein the article is industrial compostable or home compostable.

### EXAMPLES

### Abbreviations

CA-398-30 is Eastman cellulose diacetate CA-398-30; CBA is chemical blowing agent; DS is average degree of substitution; DS_{Ac} is the average degree of substitution for acetyl substituents; mp is melting point; ° C. is degree(s) Celsius; PBA is physical blowing agent. Tg is glass transition temperature; TA is triacetin;

### Example 1

Ex 1 is a formulation of CA-398-30 (DS_{Ac}-2.52, mp-230-250° C., Tg=189° C.) with TA (15 wt %).

### Example 2

Ex 2 is a formulation of CA-398-30 with TA (20 wt %).

### Extrusion

Materials were extruded on a tandem line. The 1^{st} extruder of the tandem line was a KraussMaffei ZE30 twin screw and the second extruder was KraussMaffei KE 60 single screw. The twin screw zone temperatures were set 40° C. for the feed section, 200° C. for the melting/mixing section, and 190° C. for conveying section and transfer pipe. Carbon dioxide blowing agent was injected into the twin screw extruder at levels of 1%, 1.5%, and 2% by weight of the overall formulation. The secondary extruder was set at 80° C. in the feed section, increasing to 170° C. for the remainder of the extruder and 190° C. in the die assembly. The formulation was extruded at 40 kgs/hour through an annular die and over a sizing mandrel and wound into rolls.

### Density

The density of the extruded sheet was measured using an analytical balance where the sample was immersed in water and Archimedes principle was used to measure the volume. The method is described in DIN EN ISO 1183-1, ISO 2781. Minimum 3 samples were measured and weight of each sample was between 1-5 μm.

### Surface Roughness

Surface roughness of the extruded foam sheets can be analyzed using a Bruker ContourGT optical profilometer. Surface roughness data can be measured at 3 spots on a side of the sheet. A 0.55× magnification objective can be used and the base roughness (RMS) value can be obtained.

### Results

Several foam samples were prepared with or without CBA. The foams and physical properties are shown in Table 1. Foams prepared with PBA exhibited a density range of from 0.133 to 0.197 g/cm³ with an average foam cell size of from 363 to 637 microns. On the other hand, foams prepared with PBA and CBA exhibited an improved density and average foam cell size, with a density range of from 0.101 to 0.142 g/cm³ with an average foam cell size of from 269 to 327 microns.

TABLE 1
Density and cell size of the extruder foam, with and
without CBA. Notice that the average cell size obtained
is lower when CBA is used in addition to PBA.

| | | | | | Average |
|---|---|---|---|---|---|
| | CA | CO₂ | | Foam | Foam cell |
| Sample | Formulation | loading | CBA | Density | size |
| # | (Ex #) | (wt %) | (wt %) | (g/cm³) | (microns) |
| 1 | 2 | 1 | — | 0.161 | 486 |
| 2 | 2 | 1.2 | — | 0.159 | 513 |
| 3 | 2 | 1.2 | — | 0.157 | 508 |
| 4 | 2 | 1.1 | — | 0.197 | 363 |
| 5 | 2 | 1.1 | — | 0.151 | 618 |
| 6 | 2 | 1.1 | — | 0.144 | 510 |
| 7 | 2 | 1.1 | — | 0.172 | 630 |
| 8 | 2 | 1.1 | — | 0.138 | 637 |
| 9 | 2 | 1.2 | — | 0.133 | 469 |
| 10 | 2 | 1.2 | — | 0.141 | 484 |
| 11 | 2 | 1.2 | — | 0.143 | 440 |
| 12 | 2 | 1.1 | — | 0.147 | 562 |
| 13 | 2 | 2 | Foamazole | 0.123 | 287 |
| | | | 73S (1) | | |
| 14 | 2 | 2 | Foamazole | 0.101 | 327 |
| | | | 73S (1) | | |
| 15 | 2 | 2 | Foamazole | 0.142 | 269 |
| | | | 73S (1) | | |

TABLE 2
Additional extrusion results.

| | CA | | | | | Foam | | Average | RMS | % |
|---|---|---|---|---|---|---|---|---|---|---|
| | Formu- | | CO₂ | | Foam | Density | Average | Cell Size | Surface | Decrease |
| Sample | lation | Talc | Loading | | Density | Reduction | Cell Size | Reduction | Roughness | in |
| # | (Ex #) | (wt %) | (wt %) | CBA | (g/cm³) | (%) | (microns) | (%) | (microns) | Roughness |
| 16 | 2 | — | 1.5 | — | 0.14 | — | 1149 | — | 23.4 | — |
| (control) | | | | | | | | | | |
| 17 | 2 | — | 1.5 | Foamazole | 0.131 | −6.4 | 318 | −72.3% | 20.7 | −42% |
| | | | | 73s (1) | | | | | | |
| 18 | 2 | — | 1.5 | Foamazole | 0.119 | −15 | 280 | −75.6% | 13.6 | −39% |
| | | | | 73s (2) | | | | | | |
| 19 | 2 | 1 | 1.5 | — | 0.122 | −12.9 | 295 | −74.3 | 14.3 | −26% |
| 20 | 2 | 2 | 1.5 | — | 0.117 | −16.4 | 272 | −76.3 | 17.3 | −41% |
| 21 | 2 | 1 | 1.5 | Foamazole | 0.127 | −9.3 | 217 | −81.1 | 13.9 | −39% |
| | | | | 73s (1) | | | | | | |
| 22 | 2 | 2 | 1.5 | Foamazole | 0.12 | −14.3 | 233 | −79.7 | 14.3 | −12% |
| | | | | 73s (1) | | | | | | |
| 23 | 2 | 1 | 1.5 | Foamazole | 0.115 | −17.9 | 218 | −81.0 | — | — |
| | | | | 73s (2) | | | | | | |
| 24 | 2 | 2 | 1.5 | Foamazole | 0.132 | −5.7 | 168 | −85.4 | — | — |
| | | | | 73s (2) | | | | | | |
| 25 | 2 | — | 1 | — | 0.235 | — | 1131 | — | — | — |
| (control) | | | | | | | | | | |
| 26 | 2 | — | 2 | — | 0.115 | — | 1336 | — | — | — |
| (control) | | | | | | | | | | |
| 27 | 2 | — | 1 | Foamazole | 0.161 | 15 | 276 | −76.0 | — | — |
| | | | | 73s (1) | | | | | | |
| 28 | 2 | — | 2 | Foamazole | 0.09 | −35.7 | 190 | −83.5 | — | — |
| | | | | 73s (1) | | | | | | |
| 29 | 2 | 0 | 1.5 | Foamazole | 0.112 | −20 | 295 | −74.3 | — | — |
| | | | | Bio902 (1) | | | | | | |
| 30 | 2 | 0 | 1.5 | Foamazole | 0.105 | −25.0 | 167 | −85.5 | — | — |
| | | | | Bio902 (2) | | | | | | |

1. A foamable composition comprising:
(i) a cellulose acetate;
(ii) a nucleating agent;
(iii) a plasticizer;
(iv) physical blowing agent, which is carbon dioxide; and
(v) a chemical blowing agent,
wherein:
the plasticizer is present at from 5 to 40 wt %,
the nucleating agent is present at from 0.1 to 3 wt %,
the physical blowing agent is present at from 0.1 to 5 wt %, and
the chemical blowing agent is present at from 0.1 to 5 wt %,
each based on the total weight of the composition.

2. The foamable composition of claim 1, wherein the cellulose acetate has an average degree of substitution for acetyl substituents (“DS_{Ac}”) that is from 1.8 to 2.6.

3. The foamable composition of claim 1, wherein the chemical blowing agent, comprises:
(a) a chemical blowing composition, wherein the chemical blowing composition comprises a bicarbonate salt, a carbonate salt, citric acid, or combinations thereof;
(b) a carrier polymer having a melting point that is no more than 180° C.

4. The foamable composition of claim 3, wherein the carrier polymer comprises a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof.

5. The foamable composition of claim 1, wherein the plasticizer is triacetin, triethyl citrate, polyethylene glycol, Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, glycol tribenzoate, or combinations thereof.

6. The foamable composition of claim 1, further comprising 0.1 to 50 wt % a biodegradable polymer which is different than the cellulose acetate, based on the total weight of the foamable composition.

7. The foamable composition of claim 6, wherein the biodegradable polymer is a cellulose ester that is different than the cellulose acetate, a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly (butylene succinate-co-butylene adipate) (“PBSA”), or combinations thereof.

8. The foamable composition of claim 1, wherein the physical blowing agent is present at less than 1.75 wt %.

9. The foamable composition of claim 1, wherein the physical blowing agent is present at from 1.75 to 2.5 wt %.

10. A foam formed form the composition of claim 1, wherein the foam has a density that is less than 0.2 g/cm³ and an average foam cell size of less than 350 microns.

11. A foam formed from the composition of claim 10, wherein the foam has a density is less than 0.14 g/cm³, and an average foam cell size that is from 150 to 275 microns.

12. A foam formed from the composition of claim 10, wherein the foam has a density that is less than 0.1 g/cm³, and the average foam cell size is less than 200 microns.

13. A foamable composition comprising:
(i) a cellulose acetate;
(ii) a plasticizer;
(iii) physical blowing agent, which is carbon dioxide; and
(iv) a chemical blowing agent,
wherein:
the plasticizer is present at from 5 to 40 wt %,
the physical blowing agent is present at less than 1.75 wt %, and
the chemical blowing agent is present at from 0.1 to 5 wt %,
each based on the total weight of the composition,
wherein the foamable composition is free of any physical nucleating agent as an additive.

14. A foam formed from the foamable composition of claim 13, wherein the foam has a density that is less than 0.14 g/cm³, and an average foam cell size of from 180 micron to 350 microns.

15. The foam of claim 10, wherein the cells of the foam are closed.

16. The foam of claim 10, wherein the foam is in the form of a sheet.

17. The foam of claim 16, wherein the sheet exhibits a fewer corrugations as compared to a foamed sheet prepared using only carbon dioxide as a physical blowing agent.

18. The foam of claim 10, wherein the foam comprises one or more outer surfaces and at least one skin on one of the outer surfaces of the foam.

19. An article prepared from the foam claim 10, wherein the article is biodegradable.

20. The article of claim 19, wherein the article is industrial compostable or home compostable.
